(19) United States
(12) Patent Application Publication
(10) Pub. No.: US 2026/0281914 A1
(43) Pub. Date: Sep. 17, 2026

(54) MANAGING SOUNDING REFERENCE SIGNAL SYMBOL TRANSMIT POWER IMBALANCE

(71) Applicant: Lenovo (Singapore) Pte. Limited, Singapore (SG)

(72) Inventor: Colin Frank, Park Ridge, IL (US)

(73) Assignee: Lenovo (Singapore) Pte. Limited, Singapore (SG)

(21) Appl. No.: 19/168,594

(22) PCT Filed: Mar. 29, 2024
(86) PCT No.: PCT/IB2024/053090

§ 371 Date: Sep. 24, 2025

Related U.S. Application Data
(60) Provisional application No. 63/493,644, filed on Mar. 31, 2023.
(60) Provisional application No. 63/493,663, filed on Mar. 31, 2023.

(51) Int. Cl. H04W 52/32; H04L 27/26; H04W 52/36

(52) U.S. Cl. CPC H04W 52/325; H04L 27/261; H04W 52/367

(57) ABSTRACT

Various aspects of the present disclosure relate to an apparatus for managing SRS symbol imbalance. For instance, techniques are described for correcting sounding reference signal (SRS) based uplink and downlink channels when a UE compensates for SRS power relaxations at power levels below a maximum configured power. With the assistance of the UE, for example, a gNB can validate SRS power relaxations reported by the UE. Further, if the measured relaxations are different than the power relaxations reported by the UE, the gNB can apply corresponding corrections to the SRS based channel estimates. In at least some scenarios, the UE may allow compensation of the SRS power relaxations which can be enabled and disabled under the control of the gNB and compensation of the SRS power relaxations may be addressed by adding SRS port-based offsets to an SRS power control equation.

### RELATED APPLICATIONS

This application claims priority to U.S. Provisional Application Ser. No. 63/493,644 filed Mar. 31, 2023, entitled “MANAGING SOUNDING REFERENCE SYMBOL TRANSMIT POWER IMBALANCE,” the disclosure of which is incorporated by reference herein in its entirety. This application also claims priority to U.S. Provisional Application Ser. No. 63/493,663 filed Mar. 31, 2023, entitled “MANAGING SOUNDING REFERENCE SYMBOL TRANSMIT POWER IMBALANCE,” the disclosure of which is incorporated by reference herein in its entirety.

### TECHNICAL FIELD

The present disclosure relates to wireless communications, and more specifically to sounding reference signal (SRS) transmit power.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, and for time division duplex (TDD) bands, the sounding reference signal (SRS) transmissions by a UE are used by the gNB to estimate the uplink channel. With the assumption of channel reciprocity, the gNB estimates the downlink channel as transpose of the downlink channel. However, the large (and unknown) power relaxations allowed for the SRS can result in incorrect channel estimation which can negatively impact the downlink scheduling decisions in term of rank, precoder selection, and modulation and coding scheme, resulting in a loss of throughput. Since the actual power relaxations may be much less than the maximum value allowed, the gNB cannot simply assume that the maximum power relaxations are used by the UE.

### SUMMARY

The present disclosure relates to methods, apparatuses, and systems that support managing SRS symbol imbalance. For instance, techniques are described for correcting SRS based uplink and downlink channels when a UE compensates the SRS power relaxations at power levels below Pcmax. With the assistance of the UE, for example, a gNB can validate SRS power relaxations reported by the UE. Further, if the measured relaxations are different than the power relaxations reported by the UE, the gNB can apply corresponding corrections to the SRS based channel estimates. In at least some scenarios, the UE may allow compensation of the SRS power relaxations which can be enabled and disabled under the control of the gNB and compensation of the SRS power relaxations may be addressed by adding SRS port-based offsets to an SRS power control equation.

Accordingly, the described implementations enable synchronization of UE and network behaviors which can increase signal fidelity and decrease signaling overhead.

In some implementations of the method and apparatuses described herein, an apparatus receives an indication of a power correction to be applied to an SRS port; and applies the power correction when transmitting SRS from the SRS port.

Some implementations of the method and apparatuses described herein may further include where the indication includes one or more power corrections to be applied to each SRS port of multiple SRS ports, and the apparatus causes the apparatus to apply a respective power correction to each SRS port of the multiple SRS ports; apparatus applies the power correction as a correction term to an SRS power control equation; the correction term includes one or more SRS port-based offsets; the apparatus transmits an indication of whether the apparatus applies the power correction to compensate for power relaxation for SRS transmission; the indication indicates whether the apparatus applies the power correction to compensate for power relaxation for SRS transmission when transmitting below a maximum configured transmit power; the apparatus receives an instruction to apply the power correction when transmitting below a maximum configured transmit power; and applies the power correction when transmitting the SRS from the SRS port at a transmit power below the maximum configured transmit power; the apparatus receives an instruction to not apply the power correction when transmitting below a maximum configured transmit power; and avoids applying the power correction when transmitting the SRS from the SRS port at a transmit power below the maximum configured transmit power; the apparatus transmits an indication of one or more power relaxation values for the SRS port.

In some implementations of the method and apparatuses described herein, an apparatus transmits an indication of a power correction to be applied to an SRS port; and receives one or more SRS transmitted from the SRS port.

Some implementations of the method and apparatuses described herein may further include where the indication includes one or more power corrections to be applied to each SRS port of multiple SRS ports; the indication of the power correction includes a correction term to an SRS power control equation; the correction term includes one or more SRS port-based offsets; the apparatus transmits the indication of the power correction to a second apparatus; and receives, from the second apparatus, an indication of whether the second apparatus applies the power correction to compensate for power relaxation for SRS transmission; the indication indicates whether the second apparatus applies the power correction to compensate for power relaxation for SRS transmission when transmitting below a maximum configured transmit power; the apparatus transmits the indication of the power correction to a second apparatus; and transmits, to the second apparatus, an instruction to apply the power correction when transmitting below a maximum configured transmit power; the apparatus transmits the indication of the power correction to a second apparatus; and transmits, to the second apparatus, an instruction to not apply the power correction when transmitting below a maximum configured transmit power; the apparatus transmits the indication of the power correction to a second apparatus; and receives, from the second apparatus, an indication of one or more power relaxation values for the SRS port.

### BRIEF DESCRIPTION OF THE DRAWINGS

FIG. 1 illustrates an example of a wireless communications system that supports managing SRS symbol imbalance in accordance with aspects of the present disclosure.

FIG. 2 illustrates an example system as related to managing SRS symbol imbalance in accordance with aspects of the present disclosure.

FIG. 3 illustrates an example of channel measurements taken by a gNB and a UE, as related to managing SRS symbol imbalance in accordance with aspects of the present disclosure.

FIG. 4 illustrates an example of SRS transmit power as a function of a power control setting pc with compensation of implementation losses, as related to managing SRS symbol imbalance in accordance with aspects of the present disclosure.

FIG. 5 illustrates an example of compensation of ΔT_{RxSRS} implementation losses, as related to managing SRS symbol imbalance in accordance with aspects of the present disclosure.

FIG. 6 illustrates an example of SRS transmit power as a function of a power control setting pc without compensation for implementation losses, as related to managing SRS symbol imbalance in accordance with aspects of the present disclosure.

FIGS. 7 and 8 illustrate an example of a block diagram of devices that supports managing SRS symbol imbalance in accordance with aspects of the present disclosure.

FIGS. 9-20 illustrate flowcharts of methods that support managing SRS symbol imbalance in accordance with aspects of the present disclosure.

### DETAILED DESCRIPTION

A wireless communications system includes UEs that communicate with gNBs. For TDD bands, the SRS transmissions by a UE are used by a gNB to estimate the uplink channel. With the assumption of channel reciprocity, the gNB estimates the downlink channel as transpose of the downlink channel. However, the large and often unknown power relaxations allowed for the SRS can result in incorrect channel estimation which can negatively impact the downlink scheduling decisions in term of rank, precoder selection, and modulation and coding scheme, resulting in a loss of throughput. Since the actual power relaxations may be much less than the maximum value allowed, the gNB cannot simply assume that the maximum power relaxations are used by the UE.

While both signaling and measurement techniques have the potential to solve the problem of determining the SRS relaxations and correcting the channel estimate, there may still be issues that can impact both techniques. A first issue is that it is not entirely clear exactly when the SRS power relaxations are used by the UE. Thus, even if the SRS relaxations are known, it is not clear when the gNB should use these values to correct the channel estimates. Based on the resolution of the first issue, a second issue relates to the details of how the SRS relaxations can be measured if not known.

In aspects of managing SRS symbol imbalance, this disclosure describes details for knowing when to correct the SRS based channel estimate (e.g., the first issue), and also for determining SRS transmit power imbalance and behavior (e.g., the second issue). For instance, techniques are described for correcting SRS based uplink and downlink channels when a UE compensates the SRS power relaxations at power levels below Pcmax. With the assistance of the UE, for example, a gNB can validate SRS power relaxations reported by the UE. Further, if the measured relaxations are different than the power relaxations reported by the UE, the gNB can apply corresponding corrections to the SRS based channel estimates. In at least some scenarios, the UE may allow compensation of the SRS power relaxations which can be enabled and disabled under the control of the gNB and compensation of the SRS power relaxations may be addressed by adding SRS port-based offsets to an SRS power control equation.

Accordingly, the described implementations enable synchronization of UE and network behaviors which can increase signal fidelity and decrease signaling overhead.

Aspects of the present disclosure are described in the context of a wireless communications system. Aspects of the present disclosure are further illustrated and described with reference to device diagrams and flowcharts.

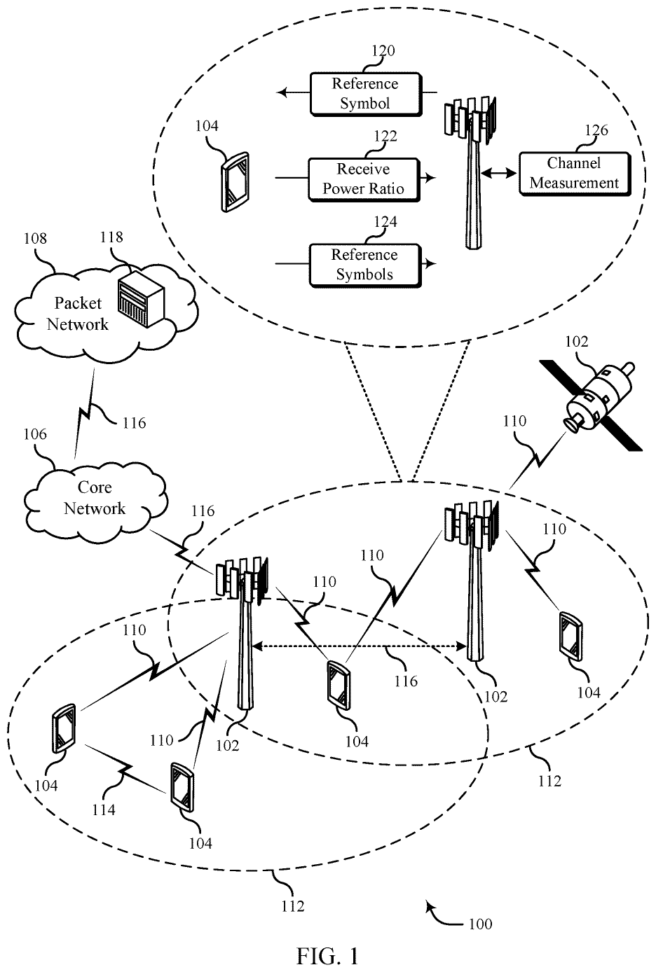

FIG. 1 illustrates an example of a wireless communications system 100 that supports managing SRS symbol imbalance in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of managing SRS symbol imbalance, as described herein. For instance, a network entity 102 (e.g., a base station) communicates a correction indication 120 to a UE 104. The correction indication 120, for instance, indicates a power correction to be applied by the UE 104 for transmitting SRS. Accordingly, and based at least in part on the correction indication 120, the UE 104 applies power correction and transmits SRS 122 to the network entity 102. The network entity 102 can determine channel conditions between the UE 104 and network entity 102 based at least in part on measurements performed on the received SRS 122.

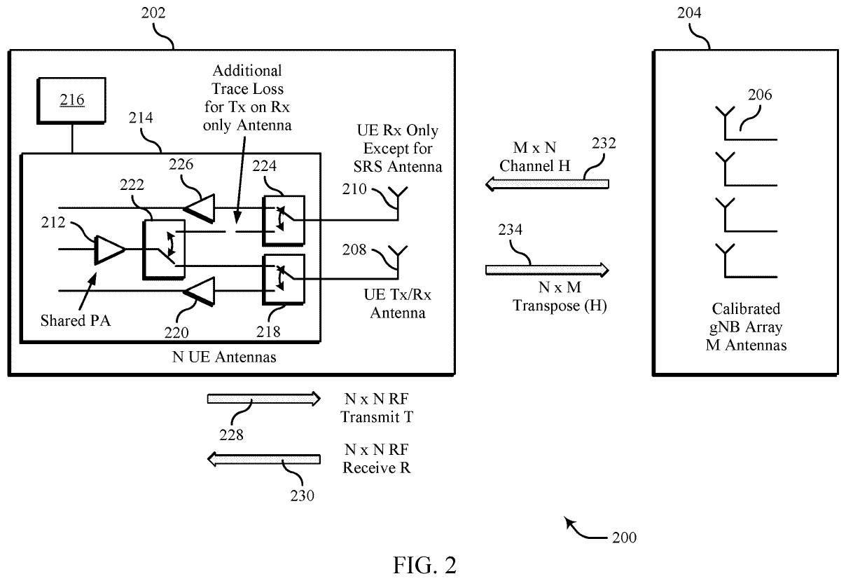

FIG. 2 illustrates an example system 200, as related to managing SRS symbol imbalance. This example system 200 includes a wireless communication device 202 (e.g., a UE 104) and a wireless communication device 204 (e.g., a network entity 102). In this example, the wireless communication device 202 can include any number of various components, such as at least a controller, a transceiver, and antenna ports. Similarly, the wireless communication device 204 can include any number of various components, such as at least antenna ports 206, and any described antenna port can be one or multiple antennas. The wireless communication device 202 can include N antennas, including at least a first antenna port 208 and a second antenna port 210. The first antenna port 208 can be a transmit and receive antenna, and the second antenna port 210 can be a receive-only antenna except for certain transmissions, such as SRS transmissions, where both antenna ports 208 and 210 use the same transmit power amplifier 212 for transmission. The wireless communication device 202 can also include a transceiver 214 and a controller 216.

The first antenna port 208 is coupled to a switch 218 of the transceiver 214. The switch 218 can switch between coupling the first antenna port 208 to receive circuitry, including a first receive low noise amplifier 220, and coupling the first antenna port 208 to transmit circuitry, including the transmit power amplifier 212 and a switch 222 of the transceiver 214. The second antenna port 210 can be coupled to a switch 224 of the transceiver 214. The switch 224 can switch between coupling the second antenna port 210 to receive circuitry, including a second receive low noise amplifier 226, and coupling the second antenna port 210 to the transmit circuitry, including the transmit power amplifier 212 and the switch 222. The switch 222 can switch between which antenna port 208 or 210 is coupled to the transmit power amplifier 212. The wireless communication device 202 can also include an N×N RF transmit channel T 228 and a N×N RF receive channel R 230.

The wireless communication device 204 includes the calibrated gNB antenna array of M antenna ports 206. A downlink channel 232 between the wireless communication device 204 and the wireless communication device 202 can be a M×N channel H. An uplink channel 234 between the wireless communication device 202 and the wireless communication device 204 can be a N×M channel that is the transpose of the downlink channel H. In operation, the transceiver 214 includes the transmit power amplifier 212, and the first antenna port 208 can be coupled to the transmit power amplifier 212 to receive power from the transmit power amplifier 212. Similarly, the second antenna port 210 can be coupled to the transmit power amplifier 212 to receive power from the transmit power amplifier 212. The controller 216 is coupled to the transceiver 214, and the controller 216 can determine transmit power difference information corresponding to a transmit power difference between transmit power on the first antenna port 208 and transmit power on the second antenna port 210. The transceiver 214 can transmit the transmit power difference information, such as via the antenna ports 208 and/or 210.

The switch 222 can be coupled between the first antenna port 208 and the transmit power amplifier 212, and similarly, the switch 222 can be coupled between the second antenna port 210 and the transmit power amplifier 212. The controller 216 can control the switch 222 to switch between transmitting SRS on the first antenna port 208 and transmitting SRS on the second antenna port 210. The second antenna port 210 may receive less power from the transmit power amplifier 212 when transmitting SRS than the first antenna port 208 due to power loss between the transmit power amplifier 212 and the second antenna port 210. In implementations, the first antenna port 208 is a transmit and receive antenna port. The second antenna port 210 is an antenna port that has an allowed transmit power reduction of its maximum output power for transmitting SRS. This allowed transmit power reduction can account for power loss between the transmit power amplifier 212 and the second antenna port 210. Accordingly, the transmit power difference information can be the transmit power difference between transmit power for SRS on the first antenna port 208 and transmit power for SRS on the second antenna port 210.

The transceiver 214 can receive reference symbols via the antenna ports 208 and 210. The controller 216 can measure a first received power of the reference symbols on the first antenna port 208, and measure a second received power of the reference symbols on the second antenna port 210. The controller 216 can then determine a received power ratio by dividing the second received power by the first received power. The determined transmit power ratio information can be the determined received power ratio. Accordingly, the received power ratio can be a first received power ratio. The controller 216 can also measure a third received power of the reference symbols on a third antenna port (not shown). The controller 216 can then determine a second received power ratio by dividing the third received power by the first received power. The transceiver 214 can transmit the second received power ratio. In implementations, the transceiver 214 can receive reference symbols. The controller 216 can measure a first received power of the reference symbols on the first antenna port 208, and can measure a second received power of the reference symbols on the second antenna port 210. The controller 216 can determine a received power ratio between the second received power from the first received power, and the determined transmit power ratio information is the determined received power ratio.

With reference to SRS transmissions, the RAN4 specification allows power relaxations for SRS transmissions that are transmitted from UE antenna ports which are receive-only antenna ports, except for SRS transmissions. As an example, these relaxations may be 6 dB for 8Rx in high bands (e.g., band n79). The SRS relaxations in the case of 4Rx antennas are described and can be specified as ΔT_{RxSRS} is applied during SRS transmission occasions with usage in SRS-ResourceSet set as ‘antennaSwitching’ when:
a) a UE transmits SRS on the second SRS resource in every configured SRS resource set when the SRS-TxSwitch capability is indicated as ‘t1r2’ or ‘t1r1-t1r2’;
b) a UE transmits SRS on the second, third, and fourth SRS resources of the total four SRS resources from all configured SRS resource set(s) consisting of one SRS port when the SRS-TxSwitch capability is indicated as ‘t1r4’, or ‘t1r4-t2r4’ or ‘t1r1-t1r2-t1r4’, or ‘t1r1-t1r2-t2r2-t1r4-t2r4’;
c) a UE transmits SRS from the second SRS port pair on the second SRS resource in every configured SRS resource set consisting of two SRS ports when the SRS-TxSwitch capability is indicated as ‘t2r4’ or ‘t1r4-t2r4’, or ‘t1r1-t1r2-t2r2-t2r4’ or ‘t1r1-t1r2-t2r2-t1r4-t2r4’; or
d) a UE transmits SRS to a DL-only carrier.

The value of ΔT_{RxSRS} is 4.5 dB for bands whose F_{UL_high} is higher than the F_{UL_low} of n79 and 3 dB for bands whose F_{UL_high} is lower than the F_{UL_low} of n79 when the device is capable of power class 3, power class 5, or power class 1.5 in the band, or when the device is capable of power class 2 in the band and ΔP_{PowerClass}=3 dB, or when a UE indicates txDiversity-r16. The value of ΔT_{RxSRS} is 7.5 dB for bands whose F_{UL_high} is higher than the F_{UL_low} of n79 and 6 dB for bands whose F_{UL_high} is lower than the F_{UL_low} of n79 during SRS transmission occasions with configured SRS resources consisting of one SRS port when the device is capable of power class 2 in the band and ΔP_{PowerClass}=0 dB and not indicating txDiversity-r16. For other SRS transmissions ΔT_{RxSRS} is zero

For TDD bands, the SRS transmissions by a UE are used by the gNB to estimate the uplink channel. With the assumption of channel reciprocity, the gNB estimates the downlink channel as transpose of the downlink channel. However, the large (and unknown) power relaxations allowed for the SRS can result in incorrect channel estimation which can negatively impact the downlink scheduling decisions in term of rank, precoder selection, and modulation and coding scheme, resulting in a loss of throughput. Since the actual power relaxations may be much less than the maximum value allowed, the gNB cannot simply assume that the maximum power relaxations are used by the UE. A technique to address this issue is to have the UE assist the gNB in determining the actual SRS relaxations.

In implementations, an M×N matrix H denotes the channel where Hᵢⱼ denotes the complex gain from the j-th UE transmit port to the i-th gNB receive port, the gNB has M ports, and the UE has N ports. The diagonal matrix R denotes the transmit power relaxations taken by the UE when transmitting SRS. Therefore:

$${R}_{ii} = 1 {0}^{- {r}_{i} / 20}$$

where rᵢ denotes the actual transmit power relaxation taken by the i-th SRS port, and Rᵢⱼ=0 for i≠j. The channel measured by the gNB is then given by:

$$\hat{H} = H R .$$

From this, the gNB infers that the downlink channel is given by:

$${\hat{H}}^{T} = {R}^{T} {H}^{T}$$

and uses this as the basis for selecting the rank, the precoding matrix, and the code rates for the downlink transmission.

If the power relaxations are known, the gNB can compensate the channel measurement for the transmit power relaxations as:

$${\hat{H}}_{comp}^{T} = {( {R}^{T} )}^{- 1} {\hat{H}}^{T} = {( {R}^{T} )}^{- 1} {R}^{T} {H}^{T} = {H}^{T}$$

However, while the gNB knows the maximum power relaxation that is allowed for each SRS port, it does not know the actual value (if any) of the power relaxation taken by the UE. If the gNB cannot accurately compensate the SRS transmit power relaxations, then downlink throughput may be negatively impacted since the SRS-based channel estimates are used for precoder selection, rank determination, and power allocation.

There are at least two possible methods for enabling the gNB to correct for the actual SRS relaxations, which include (1) to have the UE inform the gNB of the relaxation values using signaling (this approach presumes that the UE is calibrated and therefore knows the actual relaxation values), and (2) assist the gNB in measuring the power imbalance of the different gNB ports. If the UE knows the value of its SRS relaxation with some degree of accuracy for all SRS ports and all bands, then it should be possible for the UE to signal these values. The gNB can then correct its channel estimates.

Alternatively, the SRS relaxations can be determined by the network with the assistance of the UE as indicated in FIG. 1 below. As above, we consider the simplest case in which the UE and the gNB each have two antennas. As above, let H denote the channel between the UE and the gNB given by:

$$H = [ \begin{matrix}{H}_{1 , 1} & {H}_{1 , 2} \\ {H}_{2 , 1} & {H}_{2 , 2}\end{matrix} ]$$

where Hᵢⱼ denotes the complex gain from the j-th UE antenna port to the i-th gNB antenna port.

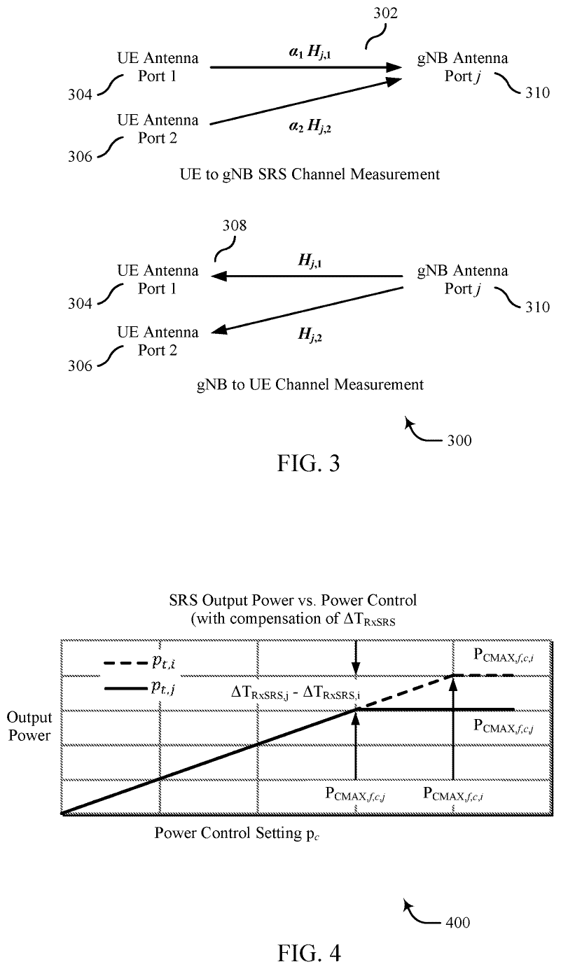

FIG. 3 illustrates an example 300 of channel measurements taken by a gNB and a UE, as related to managing SRS symbol imbalance in accordance with aspects of the present disclosure. As indicated in this example 300, the gNB (at 302) uses the SRS transmitted by the UE (e.g., from antenna port1 304 and antenna port2 306) to measure the channels α₁ H_{j,1} and α₂ H_{j,2}. The UE (at 308) can then use any reference symbols transmitted from gNB antenna port j 310 to measure the channels H_{j,1} and H_{j,2}. If the UE reports the measured ratio |H_{j,2}/H_{j,1}| to the gNB, then the gNB can use its measured ratio |α₂ H_{j,2}/α₁ H_{j,1}| to compute α₂/α₁, as:

$$\frac{{α}_{2}}{{α}_{1}} = \vert \frac{{α}_{2} {H}_{j , 2}}{{α}_{1} {H}_{j , 1}} \vert {\vert \frac{{H}_{j , 2}}{{H}_{j , 1}} \vert}^{- 1} .$$

It can be noted than any of the gNB antenna ports can be used to estimate α₂/α₁. Alternatively, multiple gNB antenna ports can be used to form independent estimates of α₂/α₁ which can then be averaged. With the value of α₂/α₁, the relaxation matrix can be expressed as:

$$R = {α}_{1} [ \begin{matrix}1 & 0 \\ 0 & \frac{{α}_{2}}{{α}_{1}}\end{matrix} ] .$$

In the case of N UE antenna ports, the N×N relaxation matrix can be expressed as the diagonal matrix:

$$R = [ \begin{matrix}1 & 0 & ⋯ & 0 \\ 0 & \frac{{α}_{2}}{{α}_{1}} & ⋯ & ⋮ \\ ⋮ & ⋮ & ⋱ & 0 \\ 0 & ⋯ & 0 & \frac{{α}_{N}}{{α}_{1}}\end{matrix} ] .$$

If no relaxation is allowed for the first UE antenna port so that α₁=1, then the matrix R is fully defined as:

$$R = [ \begin{matrix}1 & 0 & ⋯ & 0 \\ 0 & \frac{{α}_{2}}{{α}_{1}} & ⋯ & ⋮ \\ ⋮ & ⋮ & ⋱ & 0 \\ 0 & ⋯ & 0 & \frac{{α}_{N}}{{α}_{1}}\end{matrix} ]$$

Alternatively, if no relaxation is allowed for the j-th UE port, then the matrix R can be fully defined in terms of the j-th UE antenna port as:

$$R = [ \begin{matrix}\frac{{α}_{1}}{{α}_{j}} & 0 & ⋯ & 0 \\ 0 & \frac{{α}_{2}}{{α}_{j}} & ⋯ & ⋮ \\ ⋮ & ⋮ & ⋱ & 0 \\ 0 & ⋯ & 0 & \frac{{α}_{N}}{{α}_{j}}\end{matrix} ] .$$

Depending on the accuracy with which the UE knows it relaxation values ΔT_{RxSRS}, the measured values may be more or less accurate than the values reported by the UE.

As noted previously, both the signaling and measurement techniques have the potential to solve the problem of determining the SRS relaxations and correcting the channel estimate. However a first issue is that it is not entirely clear exactly when the SRS power relaxations are used by the UE. Thus, even if the SRS relaxations are known, it is not clear when the gNB should use these values to correct the channel estimates. Based on the resolution of the first issue, a second issue relates to the details of how the SRS relaxations can be measured if not known. Accordingly, in aspects of managing SRS symbol imbalance, this disclosure describes details for knowing when to correct the SRS based channel estimate (e.g., the first issue), and also for determining SRS transmit power imbalance and behavior (e.g., the second issue).

With reference to knowing when to correct the SRS based channel estimate, at least two possibilities include (1) the SRS relaxations apply only when the SRS are transmitted at or near maximum transmit power, and (2) the SRS relaxations are applied at all power levels. From the RANI specification, it seems clear that the power relaxations should not apply at power levels below P_{CMAX,f,c}, but is not clear that these relaxations due to implementation losses are to be compensated. As a result, it may be necessary to clarify the UE's expected behavior. Taking into consideration, the P_{CMAX} equations, the UE is allowed to specify its maximum configured power P_{CMAX,f,c} in the range:

$${P}_{CMAX \_ L , f , c} \leq {P}_{CMAX , f , c} \leq {P}_{CMAX \_ H , f , c}$$

$$where :$$

$${P}_{CMAX \_ L , f , c} = MIN \{ {P}_{EMAX , c} - {Δ T}_{C , c} , ( {P}_{PowerClass} - {Δ P}_{PowerClass} ) - MAX ( MAX ( {MPR}_{c} + {Δ MPR}_{c} , A - {MPR}_{c} ) + {Δ T}_{IB , c} + {Δ T}_{C , c} + {Δ T}_{RxSRS} , P - {MPR}_{c} ) \}$$

$$and :$$

$${P}_{CMAX \_ H , f , c} = MIN \{ {P}_{EMAX , c} , {P}_{PowerClass} - {Δ P}_{PowerClass} \} .$$

The upper bound on maximum configured power P_{CMAX_H,f,c} is the same for all SRS ports. Let P_{CMAX_L,f,c,i} denote a lower bound on the configured maximum power P_{CMAX,f,c,i} for the i-th UE antenna port, and let ΔT_{RxSRS,i} denote the SRS relaxation allowed for the i-th UE antenna port. Because different SRS ports can have different values of ΔT_{RxSRS}, each SRS port can set its own maximum configured power. Further, since the configured maximum power P_{CMAX,f,c,i} is not required to be equal to P_{CMAX_L,f,c,i}, the configured maximum power P_{CMAX,f,c,i} and P_{CMAX,f,c,i} for SRS ports i and j can be different for two SRS ports even if they have the same value of ΔT_{RxSRS}. Similarly, the difference in the maximum configured power P_{CMAX,f,c,i} and P_{CMAX,f,c,i} for SRS ports i and j need not be equal to the difference in ΔT_{RxSRS} for these two SRS ports.

In summary, each SRS port is allowed to set its own maximum configured power; the P_{CMAX,f,c,i} and P_{CMAX,f,c,i} for SRS ports i and j can be different for two SRS ports even if they have the same value of ΔT_{RxSRS}; and the difference in the maximum configured power P_{CMAX,f,c,i} and P_{CMAX,f,c,i} for SRS ports i and j need not be equal to the difference in ΔT_{RxSRS}. While each SRS port can set its own maximum configured power, it can be assumed that the power control commands are the same for all SRS ports (not to exclude that it may be possible to have separate power control for each SRS port). If the gNB power controls the SRS transmissions of the UE to a value pc, then the transmitted power p_{t,i} for port i is given by:

$${p}_{t , i} = MIN \{ {P}_{CMAX , f , c , i} , {p}_{c} \} ,$$

and the transmitted power p_{t,j} for port j is given by:

$${p}_{t , j} = MIN \{ {P}_{CMAX , f , c , j} , {p}_{c} \} .$$

Considering the case that P_{CMAX,f,c,i}=P_{CMAX_L,f,c,i} and P_{CMAX,f,c,j}=P_{CMAX_L,f,c,j}. With this assumption, then:

$${P}_{CMAX , f , c , i} = {P}_{CMAX , f , c , j} + ( {Δ T}_{RxSRS , i} - {Δ T}_{RxSRS , j} ) .$$

In the case that ΔT_{RxSRS,i}≥ΔT_{RxSRS,j}, then:

$${p}_{t , j} - {p}_{t , i} = \{ \begin{matrix}0 & {p}_{c} \leq {P}_{CMAX , f , c , i} \\ {p}_{c} - {P}_{CMAX , f , c , i} & {P}_{CMAX , f , c , i} \leq {p}_{c} \leq {P}_{CMAX , f , c , j} \\ {Δ T}_{RxSRS , i}^{A} - {Δ T}_{RxSRS , j}^{A} & {p}_{c} \leq {P}_{CMAX , f , c , j}\end{matrix}$$

Conversely, if ΔT_{RxSRS,j}≥ΔT_{RxSRS,i}, then:

$${p}_{t , i} - {p}_{t , j} = \{ \begin{matrix}0 & {p}_{c} \leq {P}_{CMAX , f , c , j} \\ {p}_{c} - {P}_{CMAX , f , c , j} & {P}_{CMAX , f , c , j} \leq {p}_{c} \leq {P}_{CMAX , f , c , i} \\ {Δ T}_{RxSRS , j}^{A} - {Δ T}_{RxSRS , i}^{A} & {p}_{c} \leq {P}_{CMAX , f , c , i}\end{matrix} .$$

Thus, in the case that P_{CMAX,f,c,i}=P_{CMAX_L,f,c,i} and P_{CMAX,f,c,j}=P_{CMAX_L,f,c,j}, the absolute difference |p_{t,i}−p_{t,j}| is in the range (depending on the value of p_{c}):

$$0 \leq \vert {p}_{t , i} - {p}_{t , j} \vert \leq \vert {Δ T}_{RxSRS , i} - {Δ T}_{RxSRS , j} \vert$$

FIG. 4 illustrates an example 400 of SRS transmit power as a function of a power control setting p_{c} with compensation of implementation losses, as related to managing SRS symbol imbalance in accordance with aspects of the present disclosure. In this example 400, the transmitted powers p_{t,i} and p_{t,j} for SRS ports i and j, respectively, are shown as a function of p_{c} for the case that ΔT_{RxSRS,j}≥ΔT_{RxSRS,i}.

There are two types of P_{CMAX} relaxations, and these are fundamentally different, with Type 1: MPR_{c}, ΔMPR_{c}, A-MPR_{c}, P-MPR_{c}; and Type 2: ΔT_{IB,c}, ΔT_{C,c}, ΔT_{RxSRS}. The maximum power relaxations are taken by the UE in order to meet emissions or other regulatory requirements. The UE knows both the values of these relaxations and the conditions under which they are taken. It is also possible that the UE takes power relaxations less than the maximum value allowed. For this reason, let

$${MPR}_{c}^{A} , Δ {MPR}_{c}^{A} ,$$

$$and$$

$$A - {MPR}_{c}^{A} ,$$

denote the actual power relaxations taken by the UE.

The Type 2 power relaxations are the result of implementation losses. These power relaxations exist at all output power levels unless actively compensated at power levels below P_{CMAX}. It is not clear if the specification requires that these losses be compensated below P_{CMAX} so that at the same power control setting p_{c} yields the same output power for all SRS antenna ports. Additionally, it is likely that the actual implementation losses are less than the maximum allowed. For this reason, let

$${Δ T}_{IB , c}^{A} , {Δ T}_{C , c}^{A}$$

$$and$$

$${Δ T}_{RxSRS}^{A}$$

denote the actual implementation losses.

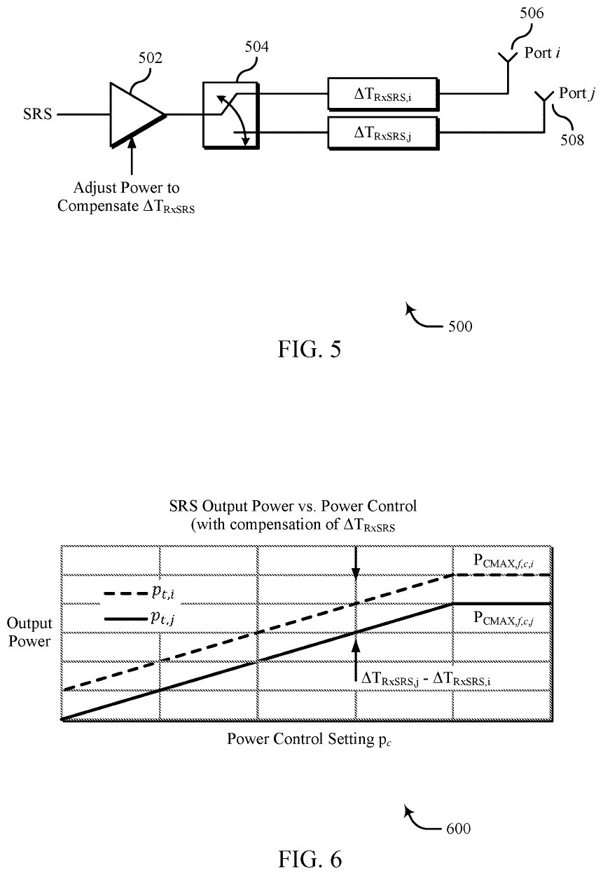

FIG. 5 illustrates an example 500 of compensation of ΔT_{RxSRS} implementation losses, as related to managing SRS symbol imbalance in accordance with aspects of the present disclosure. In order that the relaxations ΔT_{RxSRS} are not to be seen at power levels below P_{CMAX}, the UE must know the values of these relaxations and actively compensate by adjusting the power at 502 when switching at 504 between the SRS ports (e.g., port i 506, and port j 508), as shown in this example 500.

FIG. 6 illustrates an example 600 of SRS transmit power as a function of a power control setting p_{c} without compensation for implementation losses, as related to managing SRS symbol imbalance in accordance with aspects of the present disclosure. If the SRS relaxations are not compensated at power levels below P_{CMAX}, then the differences between the power relaxations will be seen at all power levels, as illustrated in this example 600.

With reference to compensating SRS power imbalance, there is some uncertainty as to when the power relaxations ΔT_{RxSRS} will affect the resulting channel estimate. According to the RANI specification, the power relaxations should only affect the value of P_{CMAX} and should not be taken until the UE output power reaches P_{CMAX}. If the relaxation ΔT_{RxSRS} is seen at all power levels, then it is easier for the gNB to correct the resulting channel estimate. However, the signal-to-noise ratio of the channel estimates for SRS ports with large values of ΔT_{RxSRS} will be degraded. Conversely, if ΔT_{RxSRS} is only seen at or near maximum power levels due to the difference in P_{CMAX} values for the different SRS ports, it may be more difficult for the gNB to correct the resulting channel estimates as the correction would depend on the power control state. Additionally, it would be necessary for the gNB to know the value of P_{CMAX} for the SRS port, or the value of P_{CMAX} would need to be inferred from a power headroom report for the same SRS port.

In aspects of this disclosure, resolutions of this issue include at least for a UE which is calibrated and knows its value of ΔT_{RxSRS} for each SRS port, require the UE to signal the value of ΔT_{RxSRS} for each SRS port; and for a UE which is not calibrated and does not know its value of ΔT_{RxSRS} for each SRS port, require the UE to assist in the measurement of ΔT_{RxSRS} (as described herein). The relaxation is then signaled to the UE.

In addition to the above, at least one of the following new requirements can be added for the UE, such as having the UE signal whether or not it compensates ΔT_{RxSRS} below P_{CMAX}, requiring the UE to compensate ΔT_{RxSRS} below P_{CMAX}, requiring the UE not to compensate ΔT_{RxSRS} below P_{CMAX}, and/or adding a new term to the power control equation for the SRS which is SRS port dependent, as given by the current power control equation for SRS.

If a UE transmits SRS based on a configuration by SRS-ResourceSet on active UL BWP b of carrier f of serving cell c using SRS power control adjustment state with index l, the UE determines the SRS transmission power P_{SRS,b,f,c}(i, qₛ, l) in SRS transmission occasion i as:

$${p}_{SRS , b , f , c}$$

To address the implementation loss ΔT_{RxSRS,i}, an SRS port dependent additional correction term

$$Δ {T}_{RxSRS , i}^{A}$$

(the actual value, not the maximum allowed value) could be added to the second equation which is configured by the network. This value can be set by the network based either on a value reported by the UE or based on measurement. This approach would bring the behavior under network control so that the gNB knows precisely when the relaxations are taken by the UE. With this approach, the correction applied by the UE in the example 500 would come under network control. The transmission power could then be defined as:

$${p}_{SRS , b , f , c}$$

where

$$Δ {T}_{R xSRS , k}^{A}$$

denotes the actual power relaxation taken by the UE for the k-th SRS port.

With reference to the measurement of

$$Δ {T}_{RxSRS , i}^{A}$$

for determining SRS transmit power imbalance and behavior, the measurement of

$$Δ {T}_{RxSRS , i}^{A}$$

will be needed for one of the following two reasons: (1) to measure the power relaxation for each SRS port if the UE is not calibrated and does not know the actual values. The value is measured by the gNB with the assistance of the UE and is then reported to the UE; or (2) if the UE reports its values

$$Δ {T}_{RxSRS , i}^{A} ,$$

measurement will be needed to verify these values.

As discussed previously, the relaxations

$$Δ {T}_{RxSRS , i}^{A}$$

can be measured by the gNB with the assistance of the UE. Specifically, the actual difference in the relaxations between SRS antenna ports 1 and 2 can be measured as:

$$Δ {T}_{R x SRS , 2}^{A} - Δ {T}_{RxSRS , 1}^{A} = 20 {log}_{10} ( \frac{{α}_{2}}{{α}_{1}} ) ,$$

$$where$$

$$\frac{{α}_{2}}{{α}_{1}} = \vert \frac{{α}_{2} {H}_{j , 2}}{{α}_{1} {H}_{j , 1}} \vert {\vert \frac{{H}_{j , 2}}{{H}_{j , 1}} \vert}^{- 1} .$$

Further, there additional issues that can be addressed with these measurements. For example, because the channels H_{j,1} and H_{j,2} are time varying, the uplink and downlink measurements must be taken contemporaneously. Therefore, the uplink symbols used to measure α₁H_{j,1} and α₂H_{j,2} must be time adjacent or nearly time adjacent to the downlink symbols used to measure H_{j,1} and H_{j,2}. The allowed time separation is dependent on the maximum Doppler frequency that is expected on the channel, which depends both on the maximum velocity and the carrier frequency. Additionally, because the channels H_{j,1} and H_{j,2} are frequency dependent, the resource blocks used to measure α₁ H_{j,1} and α₂ H_{j,2} must be the same or nearly the same as the resource blocks used to measure H_{j,1} and H_{j,2}.

Additionally, the measurements must be taken at a power level for which the difference

$$Δ {T}_{R xSRS , i}^{A} - Δ {T}_{R x S RS , j}^{A}$$

can be observed. As indicated in the example 400, if the UE compensates for the implementation loss

$$Δ {T}_{RxSRS , i}^{A}$$

at power levels below P_{CMAX}, then the power relaxations will only be seen at or near P_{CMAX}. For this type of UE implementation, the SRS antenna ports are power controlled to P_{CMAX} for the difference to be seen. The measurements can be taken opportunistically when the SRS ports are at P_{CMAX}, or alternatively, the SRS ports can be power controlled to P_{CMAX} as part of a calibration process.

If the UE does not compensate the relaxations

$$Δ {T}_{RxSRS , i}^{A}$$

as in the example 600, then the differences

$$Δ {T}_{R xSRS , i}^{A} - Δ {T}_{R x S RS , j}^{A}$$

can be measured at any power level if the network is aware of this behavior. Alternatively, the UE may have the capability to enable or disable power compensation at the direction of the gNB. This capability could be used for calibration only, or alternatively, power compensation could be disabled so that the power difference between the two SRS ports is the same at all power levels and can thus be corrected by the gNB. In order to determine whether or not the UE compensates the SRS power relaxations at power levels below P_{CMAX}, the difference

$$Δ {T}_{R xSRS , i}^{A} - Δ {T}_{R x S RS , j}^{A}$$

at P_{CMAX} is measured, and also at a power level which is at least the maximum allowed SRS power relaxation below P_{CMAX}. If the measured values are approximately the same, then it follows that the UE does not compensate SRS power relaxations below P_{CMAX}.

If the mapping of SRS ports is changed, the UE indicates the mapping change along with the new set of SRS relaxations. If the UE is not calibrated such that the UE can report the SRS relaxations, then the new relaxations are measured by the gNB with the assistance of the UE. It can be expected that the SRS port relaxations will be band dependent. Currently, the maximum power relaxations that are allowed depend on whether or not the upper edge of the uplink is greater than or less than the lower edge of band n79, with larger power relaxations allowed if the upper edge of the uplink is greater than this threshold. While this granularity may be adequate for specifying the maximum relaxations, it is not sufficient for reporting or measuring the actual values of these power relaxations.

If the UE reports a value

$$Δ {T}_{R xSRS , i}^{A}$$

for the i-th port, it must use this same value (in place of the maximum allowed value) when computing its value P_{CMAX_L,f,c,i}. Further, if the gNB measures

$$Δ {T}_{RxSRS , i}^{A}$$

(with the assistance of the UE) and reports the value of the UE, the UE must use this same value when computing its value P_{CMAX_L,f,c,i}. With reference to other considerations, virtualized antenna ports cannot be used for downlink scheduling unless the same combining coefficients are used for reception as transmission. Additionally, the technique does not separate the measurement of ΔT_{RxSRS} from the measurement of ΔT_{IB,c} and ΔT_{C,c}. However, ΔT_{IB,c} and ΔT_{C,c} should be the same for all SRS ports, and thus these components should cancel when taking the difference to determine

$$Δ {T}_{RxSRS , i}^{A} - Δ {T}_{RxSRS , j}^{A} .$$

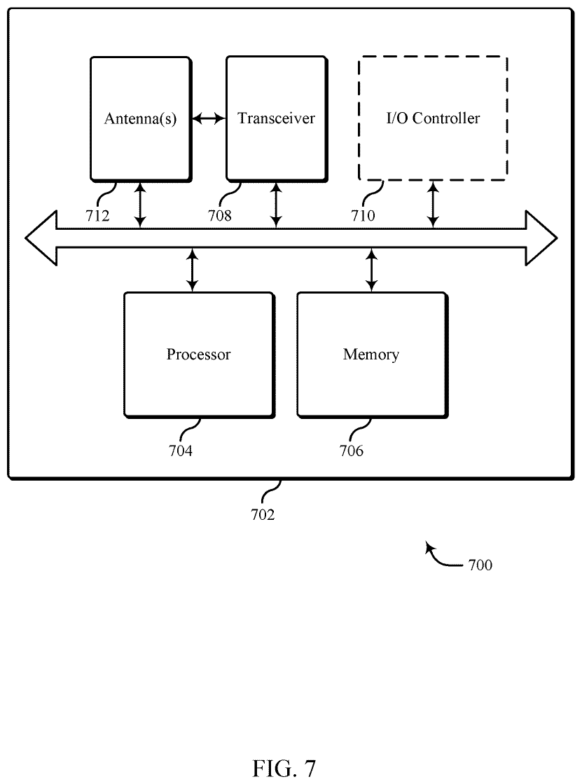

FIG. 7 illustrates an example of a block diagram 700 of a device 702 that supports managing SRS symbol imbalance in accordance with aspects of the present disclosure. The device 702 may be an example of a UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for receiving an indication of a power correction to be applied to an SRS port; and applying the power correction when transmitting SRS from the SRS port.

Additionally, the processor 704 may be configured as or otherwise support any one or combination of where the indication includes one or more power corrections to be applied to each SRS port of multiple SRS ports, and the method further includes applying a respective power correction to each SRS port of the multiple SRS ports; further including apply the power correction as a correction term to an SRS power control equation; the correction term includes one or more SRS port-based offsets; further including transmitting an indication of whether the power correction is applied to compensate for power relaxation for SRS transmission; the indication indicates whether the power correction is applied to compensate for power relaxation for SRS transmission when transmitting below a maximum configured transmit power; further including: receiving an instruction to apply the power correction when transmitting below a maximum configured transmit power; and applying the power correction when transmitting the SRS from the SRS port at a transmit power below the maximum configured transmit power; further including: receiving an instruction to not apply the power correction when transmitting below a maximum configured transmit power; and avoiding applying the power correction when transmitting the SRS from the SRS port at a transmit power below the maximum configured transmit power; further including transmitting an indication of one or more power relaxation values for the SRS port.

As a further example, the processor 704 may support wireless communication at the device 702 in accordance with examples as disclosed herein. The processor 704 may be configured as or otherwise support a means for receiving, at a UE and from a network entity, a reference symbol; measuring a first receive power of the reference symbol at a first SRS port and a second receive power of the reference symbol at a second SRS port; and transmitting, to the network entity: a ratio of the first receive power to the second receive power; a first reference symbol via the first SRS port; and a second reference symbol via the second SRS port.

Additionally, the processor 704 may be configured as or otherwise support any one or combination of transmitting the first reference symbol and the second reference symbol using approximately a same resource block via which the reference symbol is received from the network entity; further including receiving the reference symbol and transmit the first reference symbol and the second reference symbol within a time window determined as a function of a Doppler frequency; further including: receiving an instruction from the network entity to transmit the first reference symbol from the first UE SRS port and the second reference symbol from the second SRS port at a first power level, and transmit a third reference symbol from the first UE SRS port and a fourth reference symbol from the second UE SRS port at a second power level; and transmitting the first reference symbol from the first UE SRS port and the second reference symbol from the second SRS port at the first power level and transmitting the third reference symbol from the first UE SRS port and the fourth reference symbol from the second UE SRS port at the second power level; further including: receiving an instruction from the network to disable power compensation prior to transmission of the first reference symbol and the second reference symbol; and transmitting the first reference symbol and the second reference symbol without power compensation.

Additionally, or alternatively, the processor 704 may be configured as or otherwise support a means to receive an indication of a power correction to be applied to a SRS port; and apply the power correction when transmitting SRS from the SRS port.

Additionally, the wireless communication at the device 702 may include any one or combination of where the indication includes one or more power corrections to be applied to each SRS port of multiple SRS ports, and the processor is configured to cause the apparatus to apply a respective power correction to each SRS port of the multiple SRS ports; the processor is configured to cause the apparatus to apply the power correction as a correction term to an SRS power control equation; the correction term includes one or more SRS port-based offsets; the processor is configured to cause the apparatus to transmit an indication of whether the apparatus applies the power correction to compensate for power relaxation for SRS transmission; the indication indicates whether the apparatus applies the power correction to compensate for power relaxation for SRS transmission when transmitting below a maximum configured transmit power; the processor is configured to cause the apparatus to: receive an instruction to apply the power correction when transmitting below a maximum configured transmit power; and apply the power correction when transmitting the SRS from the SRS port at a transmit power below the maximum configured transmit power; the processor is configured to cause the apparatus to: receive an instruction to not apply the power correction when transmitting below a maximum configured transmit power; and avoid applying the power correction when transmitting the SRS from the SRS port at a transmit power below the maximum configured transmit power; the processor is configured to cause the apparatus to transmit an indication of one or more power relaxation values for the SRS port.

Additionally, or alternatively, the processor 704 may be configured as or otherwise support a means to receive, at a UE and from a network entity, a reference symbol; measure a first receive power of the reference symbol at a first SRS port and a second receive power of the reference symbol at a second SRS port; and transmit, to the network entity: a ratio of the first receive power to the second receive power; a first reference symbol via the first SRS port; and a second reference symbol via the second SRS port.

Additionally, the wireless communication at the device 702 may include any one or combination of where the processor is configured to cause the apparatus to transmit the first reference symbol and the second reference symbol using approximately a same resource block via which the reference symbol is received from the network entity; the processor is configured to cause the apparatus to receive the reference symbol and transmit the first reference symbol and the second reference symbol within a time window determined as a function of a Doppler frequency; the processor is configured to cause the apparatus to: receive an instruction from the network entity to transmit the first reference symbol from the first UE SRS port and the second reference symbol from the second SRS port at a first power level, and transmit a third reference symbol from the first UE SRS port and a fourth reference symbol from the second UE SRS port at a second power level; and transmit the first reference symbol from the first UE SRS port and the second reference symbol from the second SRS port at the first power level, and transmit the third reference symbol from the first UE SRS port and the fourth reference symbol from the second UE SRS port at the second power level; the processor is configured to cause the apparatus to: receive an instruction from the network to disable power compensation prior to transmission of the first reference symbol and the second reference symbol; and transmit the first reference symbol and the second reference symbol without power compensation.

The processor 704 of the device 702, such as a UE 104, may support wireless communication in accordance with examples as disclosed herein. The processor 704 includes at least one controller coupled with at least one memory, and the at least one controller is configured to and/or operable to cause the processor to receive an indication of a power correction to be applied to a SRS port; and apply the power correction when transmitting SRS from the SRS port. The controller may further be configured to and/or operable to cause the processor 704 to perform any of the various operations described herein, such as with reference to the UE 104.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

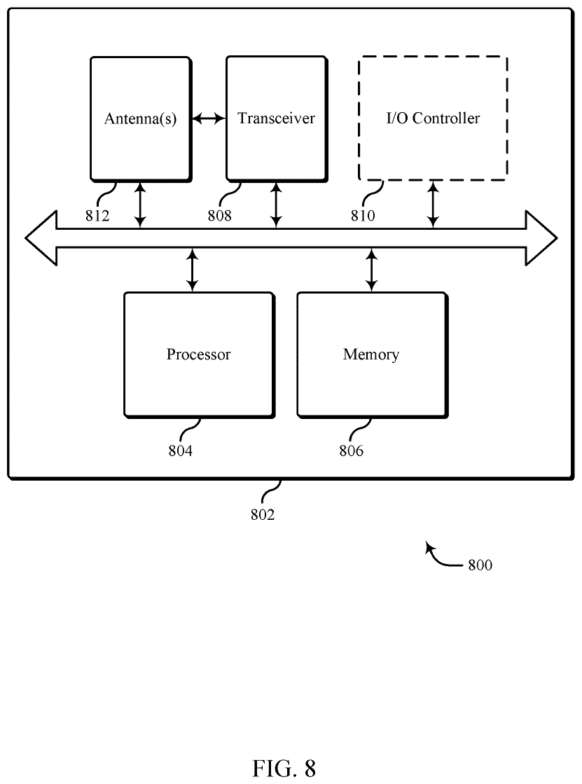

FIG. 8 illustrates an example of a block diagram 800 of a device 802 that supports managing SRS symbol imbalance in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for transmitting an indication of a power correction to be applied to a SRS port; and receiving one or more SRS transmitted from the SRS port.

Additionally, the processor 804 may be configured as or otherwise support any one or combination of where the indication includes one or more power corrections to be applied to each SRS port of multiple SRS ports; the indication of the power correction includes a correction term to an SRS power control equation; the correction term includes one or more SRS port-based offsets; further including: transmitting the indication of the power correction to a second apparatus; and receiving, from the second apparatus, an indication of whether the second apparatus applies the power correction to compensate for power relaxation for SRS transmission; the indication indicates whether the second apparatus applies the power correction to compensate for power relaxation for SRS transmission when transmitting below a maximum configured transmit power; further including: transmitting the indication of the power correction to a second apparatus; and transmitting, to the second apparatus, an instruction to apply the power correction when transmitting below a maximum configured transmit power; further including: transmitting the indication of the power correction to a second apparatus; and transmitting, to the second apparatus, an instruction to not apply the power correction when transmitting below a maximum configured transmit power; further including: transmitting the indication of the power correction to a second apparatus; and receiving, from the second apparatus, an indication of one or more power relaxation values for the SRS port.

For example, the processor 804 may support wireless communication at the device 802 in accordance with examples as disclosed herein. The processor 804 may be configured as or otherwise support a means for transmitting, by a network entity to a user equipment (UE), a reference symbol from a first network entity antenna port; receiving, from the UE, a first ratio of a UE receive power of the reference symbol; measuring a first receive power of a first reference symbol received from the UE and a second receive power of a second reference symbol received from the UE, and generating a second ratio based at least in part on the first receive power and the second receive power; and performing a channel measurement correction based at least in part on the first ratio and the second ratio.

Additionally, the processor 804 may be configured as or otherwise support any one or combination of where the UE receive power includes a receive power for the reference symbol at a first UE SRS port and a receive power for the reference symbol at a second UE SRS port; the first ratio includes a ratio of the receive power at the first UE SRS port to the receive power at the second UE SRS port; further including transmitting the reference symbol using approximately a same resource block via which the first reference symbol and the second reference symbol are received from the UE; further including transmitting the reference symbol and receiving the first reference symbol and the second reference symbol from the UE within a time window determined as a function of a Doppler frequency; further including receiving the first reference symbol from a first UE SRS port and receive the second reference symbol from a second UE SRS port; further including measuring the first receive power and the second receive power based at least in part on reception of the first reference symbol and the second reference symbol at the first network entity antenna port.

Additionally, the processor 804 may be configured as or otherwise support any one or combination of determining a power relaxation ratio of a power relaxation of a first UE SRS port to a power relaxation of a second UE SRS port as a ratio of the second ratio to the first ratio, and performing the channel measurement correction based at least in part on the power relaxation ratio; further including transmitting an instruction to the UE to transmit the first reference symbol from a first UE SRS port and the second reference symbol from a second SRS port at a first power level, and transmitting a third reference symbol from the first UE SRS port and a fourth reference symbol from the second UE SRS port at a second power level; further including transmitting an instruction to the UE to disable power compensation prior to transmission of the first reference symbol and the second reference symbol.

Additionally, or alternatively, the device 802, in accordance with examples as disclosed herein, may transmit an indication of a power correction to be applied to a SRS port; and receive one or more SRS transmitted from the SRS port.

Additionally, the wireless communication at the device 802 may include any one or combination of where the indication includes one or more power corrections to be applied to each SRS port of multiple SRS ports; the indication of the power correction includes a correction term to an SRS power control equation; the correction term includes one or more SRS port-based offsets; the processor is configured to cause the apparatus to: transmit the indication of the power correction to a second apparatus; and receive, from the second apparatus, an indication of whether the second apparatus applies the power correction to compensate for power relaxation for SRS transmission; the indication indicates whether the second apparatus applies the power correction to compensate for power relaxation for SRS transmission when transmitting below a maximum configured transmit power; the processor is configured to cause the apparatus to: transmit the indication of the power correction to a second apparatus; and transmit, to the second apparatus, an instruction to apply the power correction when transmitting below a maximum configured transmit power; the processor is configured to cause the apparatus to: transmit the indication of the power correction to a second apparatus; and transmit, to the second apparatus, an instruction to not apply the power correction when transmitting below a maximum configured transmit power; the processor is configured to cause the apparatus to: transmit the indication of the power correction to a second apparatus; and receive, from the second apparatus, an indication of one or more power relaxation values for the SRS port.

Additionally, or alternatively, the device 802, in accordance with examples as disclosed herein, may transmit, by a network entity to a user equipment (UE), a reference symbol from a first network entity antenna port; receive, from the UE, a first ratio of a UE receive power of the reference symbol; measure a first receive power of a first reference symbol received from the UE and a second receive power of a second reference symbol received from the UE, and generate a second ratio based at least in part on the first receive power and the second receive power; and perform a channel measurement correction based at least in part on the first ratio and the second ratio.

Additionally, the wireless communication at the device 802 may include any one or combination of where the UE receive power includes a receive power for the reference symbol at a first UE SRS port and a receive power for the reference symbol at a second UE SRS port; the first ratio includes a ratio of the receive power at the first UE SRS port to the receive power at the second UE SRS port; the processor is configured to cause the apparatus to transmit the reference symbol using approximately a same resource block via which the first reference symbol and the second reference symbol are received from the UE; the processor is configured to cause the apparatus to transmit the reference symbol and receive the first reference symbol and the second reference symbol from the UE within a time window determined as a function of a Doppler frequency; the processor is configured to cause the apparatus to receive the first reference symbol from a first UE SRS port and receive the second reference symbol from a second UE SRS port.

Additionally, the wireless communication at the device 802 may include any one or combination of where the processor is configured to cause the apparatus to measure the first receive power and the second receive power based at least in part on reception of the first reference symbol and the second reference symbol at the first network entity antenna port; the processor is configured to cause the apparatus to determine a power relaxation ratio of a power relaxation of a first UE SRS port to a power relaxation of a second UE SRS port as a ratio of the second ratio to the first ratio, and perform the channel measurement correction based at least in part on the power relaxation ratio; the processor is configured to cause the apparatus to transmit an instruction to the UE to transmit the first reference symbol from a first UE SRS port and the second reference symbol from a second SRS port at a first power level, and transmit a third reference symbol from the first UE SRS port and a fourth reference symbol from the second UE SRS port at a second power level; the processor is configured to cause the apparatus to transmit an instruction to the UE to disable power compensation prior to transmission of the first reference symbol and the second reference symbol

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device 802. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

FIG. 9 illustrates a flowchart of a method 900 that supports managing SRS symbol imbalance in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving an indication of a power correction to be applied to an SRS port. The operations of 902 may be performed in accordance with examples as described herein. In some implementations, aspects of the operations of 902 may be performed by a device as described with reference to FIG. 1.

At 904, the method may include applying the power correction when transmitting SRS from the SRS port. The operations of 904 may be performed in accordance with examples as described herein. In some implementations, aspects of the operations of 904 may be performed by a device as described with reference to FIG. 1.

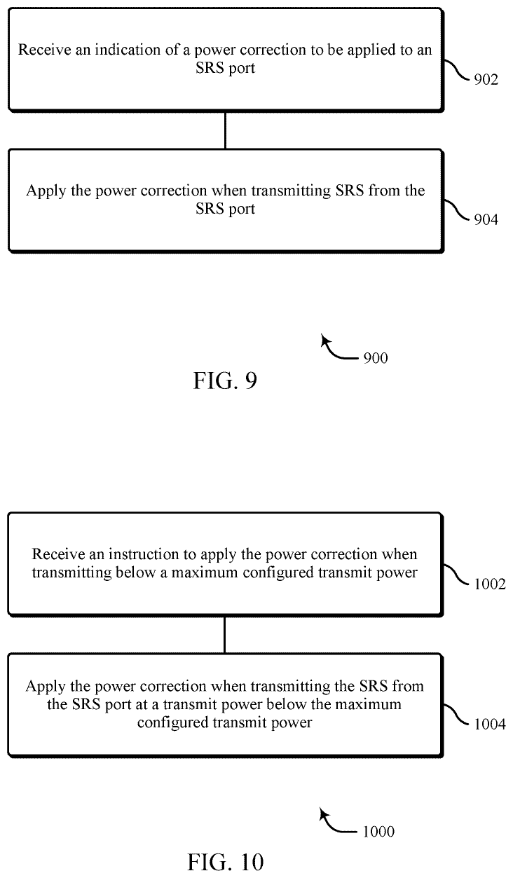

FIG. 10 illustrates a flowchart of a method 1000 that supports managing SRS symbol imbalance in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include receiving an instruction to apply the power correction when transmitting below a maximum configured transmit power. The operations of 1002 may be performed in accordance with examples as described herein. In some implementations, aspects of the operations of 1002 may be performed by a device as described with reference to FIG. 1.

At 1004, the method may include applying the power correction when transmitting the SRS from the SRS port at a transmit power below the maximum configured transmit power. The operations of 1004 may be performed in accordance with examples as described herein. In some implementations, aspects of the operations of 1004 may be performed by a device as described with reference to FIG. 1.

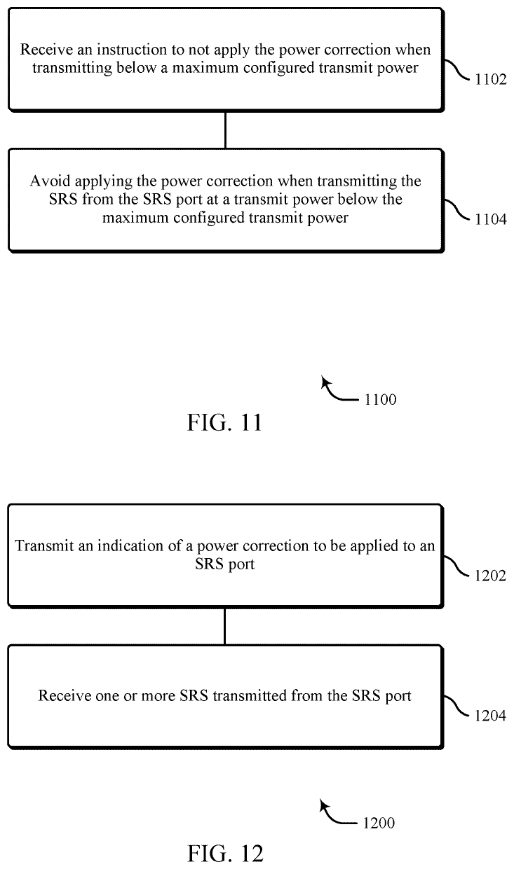

FIG. 11 illustrates a flowchart of a method 1100 that supports managing SRS symbol imbalance in accordance with aspects of the present disclosure. The operations of the method 1100 may be implemented by a device or its components as described herein. For example, the operations of the method 1100 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving an instruction to not apply the power correction when transmitting below a maximum configured transmit power. The operations of 1102 may be performed in accordance with examples as described herein. In some implementations, aspects of the operations of 1102 may be performed by a device as described with reference to FIG. 1.

At 1104, the method may include avoiding applying the power correction when transmitting the SRS from the SRS port at a transmit power below the maximum configured transmit power. The operations of 1104 may be performed in accordance with examples as described herein. In some implementations, aspects of the operations of 1104 may be performed by a device as described with reference to FIG. 1.

FIG. 12 illustrates a flowchart of a method 1200 that supports managing SRS symbol imbalance in accordance with aspects of the present disclosure. The operations of the method 1200 may be implemented by a device or its components as described herein. For example, the operations of the method 1200 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include transmitting an indication of a power correction to be applied to an SRS port. The operations of 1202 may be performed in accordance with examples as described herein. In some implementations, aspects of the operations of 1202 may be performed by a device as described with reference to FIG. 1.

At 1204, the method may include receiving one or more SRS transmitted from the SRS port. The operations of 1204 may be performed in accordance with examples as described herein. In some implementations, aspects of the operations of 1204 may be performed by a device as described with reference to FIG. 1.

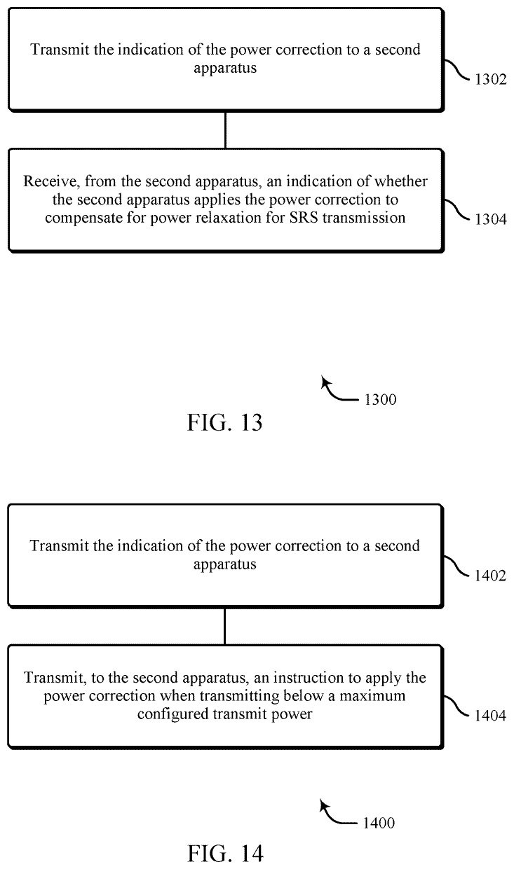

FIG. 13 illustrates a flowchart of a method 1300 that supports managing SRS symbol imbalance in accordance with aspects of the present disclosure. The operations of the method 1300 may be implemented by a device or its components as described herein. For example, the operations of the method 1300 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include transmitting the indication of the power correction to a second apparatus. The operations of 1302 may be performed in accordance with examples as described herein. In some implementations, aspects of the operations of 1302 may be performed by a device as described with reference to FIG. 1.

At 1304, the method may include receiving, from the second apparatus, an indication of whether the second apparatus applies the power correction to compensate for power relaxation for SRS transmission. The operations of 1304 may be performed in accordance with examples as described herein. In some implementations, aspects of the operations of 1304 may be performed by a device as described with reference to FIG. 1.

FIG. 14 illustrates a flowchart of a method 1400 that supports managing SRS symbol imbalance in accordance with aspects of the present disclosure. The operations of the method 1400 may be implemented by a device or its components as described herein. For example, the operations of the method 1400 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1402, the method may include transmitting the indication of the power correction to a second apparatus. The operations of 1402 may be performed in accordance with examples as described herein. In some implementations, aspects of the operations of 1402 may be performed by a device as described with reference to FIG. 1.

At 1404, the method may include transmitting, to the second apparatus, an instruction to apply the power correction when transmitting below a maximum configured transmit power. The operations of 1404 may be performed in accordance with examples as described herein. In some implementations, aspects of the operations of 1404 may be performed by a device as described with reference to FIG. 1.

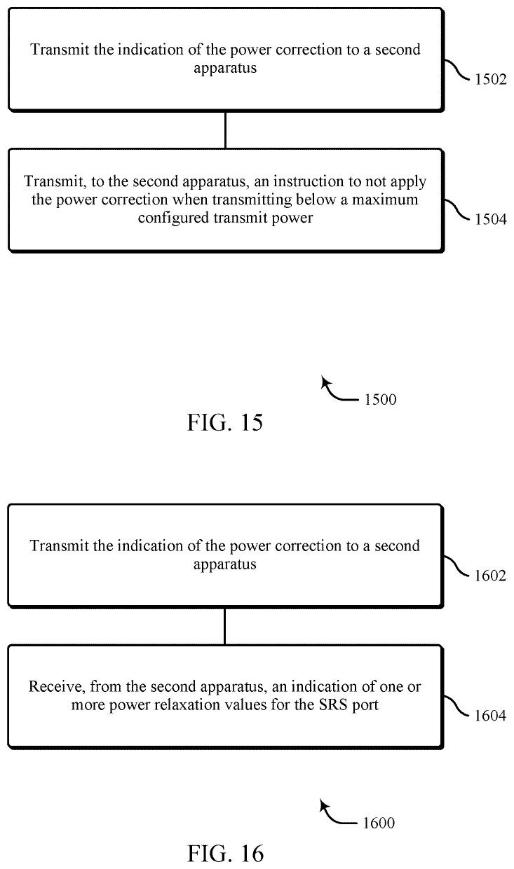

FIG. 15 illustrates a flowchart of a method 1500 that supports managing SRS symbol imbalance in accordance with aspects of the present disclosure. The operations of the method 1500 may be implemented by a device or its components as described herein. For example, the operations of the method 1500 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1502, the method may include transmitting the indication of the power correction to a second apparatus. The operations of 1502 may be performed in accordance with examples as described herein. In some implementations, aspects of the operations of 1502 may be performed by a device as described with reference to FIG. 1.

At 1504, the method may include transmitting, to the second apparatus, an instruction to not apply the power correction when transmitting below a maximum configured transmit power. The operations of 1504 may be performed in accordance with examples as described herein. In some implementations, aspects of the operations of 1504 may be performed by a device as described with reference to FIG. 1.

FIG. 16 illustrates a flowchart of a method 1600 that supports managing SRS symbol imbalance in accordance with aspects of the present disclosure. The operations of the method 1600 may be implemented by a device or its components as described herein. For example, the operations of the method 1600 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1602, the method may include transmitting the indication of the power correction to a second apparatus. The operations of 1602 may be performed in accordance with examples as described herein. In some implementations, aspects of the operations of 1602 may be performed by a device as described with reference to FIG. 1.

At 1604, the method may include receiving, from the second apparatus, an indication of one or more power relaxation values for the SRS port. The operations of 1604 may be performed in accordance with examples as described herein. In some implementations, aspects of the operations of 1604 may be performed by a device as described with reference to FIG. 1.

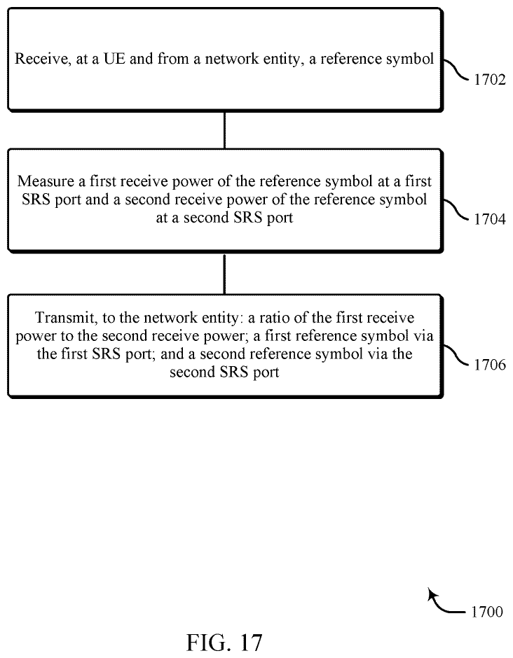

FIG. 17 illustrates a flowchart of a method 1700 that supports managing SRS symbol imbalance in accordance with aspects of the present disclosure. The operations of the method 1700 may be implemented by a device or its components as described herein. For example, the operations of the method 1700 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1702, the method may include receiving, at a UE and from a network entity, a reference symbol. The operations of 1702 may be performed in accordance with examples as described herein. In some implementations, aspects of the operations of 1702 may be performed by a device as described with reference to FIG. 1.

At 1704, the method may include measuring a first receive power of the reference symbol at a first SRS port and a second receive power of the reference symbol at a second SRS port. The operations of 1704 may be performed in accordance with examples as described herein. In some implementations, aspects of the operations of 1704 may be performed by a device as described with reference to FIG. 1.

At 1706, the method may include transmitting, to the network entity: a ratio of the first receive power to the second receive power; a first reference symbol via the first SRS port; and a second reference symbol via the second SRS port. The operations of 1706 may be performed in accordance with examples as described herein. In some implementations, aspects of the operations of 1706 may be performed by a device as described with reference to FIG. 1.

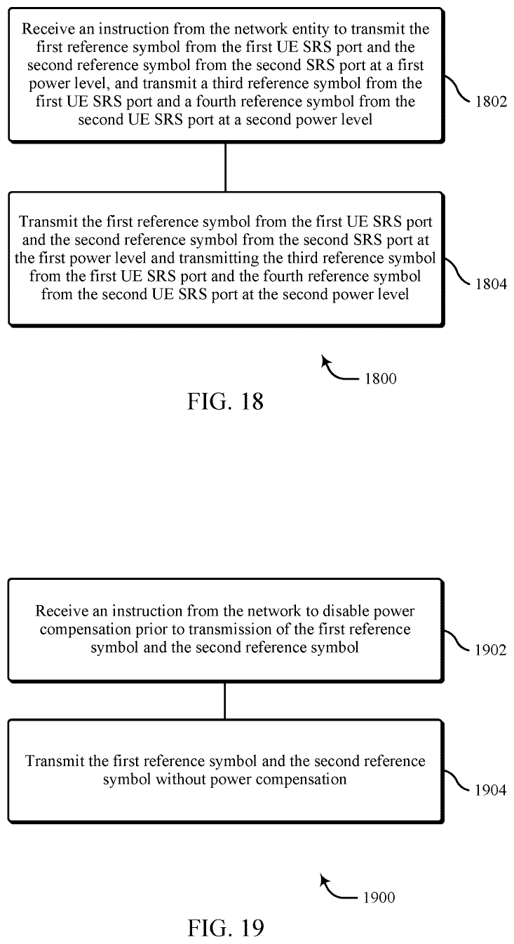

FIG. 18 illustrates a flowchart of a method 1800 that supports managing SRS symbol imbalance in accordance with aspects of the present disclosure. The operations of the method 1800 may be implemented by a device or its components as described herein. For example, the operations of the method 1800 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1802, the method may include receiving an instruction from the network entity to transmit the first reference symbol from the first UE SRS port and the second reference symbol from the second SRS port at a first power level, and transmit a third reference symbol from the first UE SRS port and a fourth reference symbol from the second UE SRS port at a second power level. The operations of 1802 may be performed in accordance with examples as described herein. In some implementations, aspects of the operations of 1802 may be performed by a device as described with reference to FIG. 1.

At 1804, the method may include transmitting the first reference symbol from the first UE SRS port and the second reference symbol from the second SRS port at the first power level and transmitting the third reference symbol from the first UE SRS port and the fourth reference symbol from the second UE SRS port at the second power level. The operations of 1804 may be performed in accordance with examples as described herein. In some implementations, aspects of the operations of 1804 may be performed by a device as described with reference to FIG. 1.

FIG. 19 illustrates a flowchart of a method 1900 that supports managing SRS symbol imbalance in accordance with aspects of the present disclosure. The operations of the method 1900 may be implemented by a device or its components as described herein. For example, the operations of the method 1900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1902, the method may include receiving an instruction from the network to disable power compensation prior to transmission of the first reference symbol and the second reference symbol. The operations of 1902 may be performed in accordance with examples as described herein. In some implementations, aspects of the operations of 1902 may be performed by a device as described with reference to FIG. 1.

At 1904, the method may include transmitting the first reference symbol and the second reference symbol without power compensation. The operations of 1904 may be performed in accordance with examples as described herein. In some implementations, aspects of the operations of 1904 may be performed by a device as described with reference to FIG. 1.

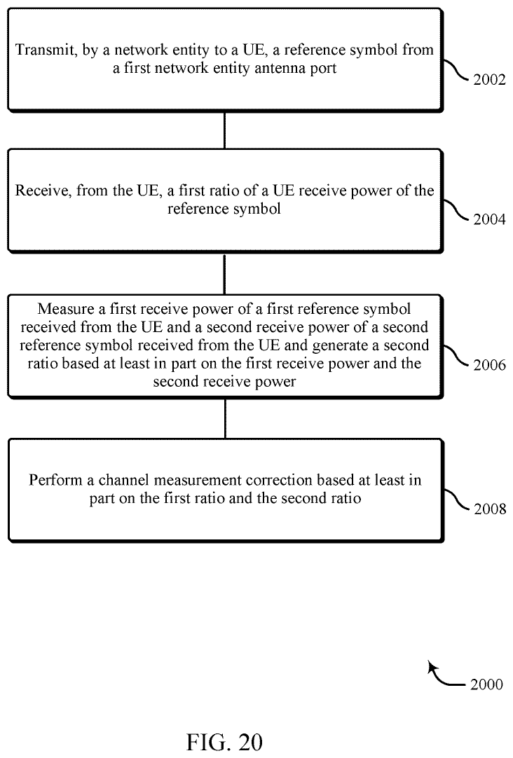

FIG. 20 illustrates a flowchart of a method 2000 that supports managing SRS symbol imbalance in accordance with aspects of the present disclosure. The operations of the method 2000 may be implemented by a device or its components as described herein. For example, the operations of the method 2000 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 2002, the method may include transmitting, by a network entity to a UE, a reference symbol from a first network entity antenna port. The operations of 2002 may be performed in accordance with examples as described herein. In some implementations, aspects of the operations of 2002 may be performed by a device as described with reference to FIG. 1.

At 2004, the method may include receiving, from the UE, a first ratio of a UE receive power of the reference symbol. The operations of 2004 may be performed in accordance with examples as described herein. In some implementations, aspects of the operations of 2004 may be performed by a device as described with reference to FIG. 1.

At 2006, the method may include measuring a first receive power of a first reference symbol received from the UE and a second receive power of a second reference symbol received from the UE and generating a second ratio based at least in part on the first receive power and the second receive power. The operations of 2006 may be performed in accordance with examples as described herein. In some implementations, aspects of the operations of 2006 may be performed by a device as described with reference to FIG. 1.

At 2008, the method may include performing a channel measurement correction based at least in part on the first ratio and the second ratio. The operations of 2008 may be performed in accordance with examples as described herein. In some implementations, aspects of the operations of 2008 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive an indication of a power correction to be applied to a sounding reference signal (SRS) port; and
apply the power correction when transmitting SRS from the SRS port.

2. The UE of claim 1, wherein the indication comprises one or more power corrections to be applied to each SRS port of multiple SRS ports, and the at least one processor is operable to cause the UE to apply a respective power correction to each SRS port of the multiple SRS ports.

3. The UE of claim 1, wherein the at least one processor is operable to cause the UE to apply the power correction as a correction term to an SRS power control equation.

4. The UE of claim 3, wherein the correction term comprises one or more SRS port-based offsets.

5. The UE of claim 1, wherein the at least one processor is operable to cause the UE to transmit an indication of whether the UE applies the power correction to compensate for power relaxation for SRS transmission.

6. The UE of claim 5, wherein the indication indicates whether the UE applies the power correction to compensate for the power relaxation for SRS transmission when transmitting below a maximum configured transmit power.

7. The UE of claim 1, wherein the at least one processor is operable to cause the UE to:
receive an instruction to apply the power correction when transmitting below a maximum configured transmit power; and
apply the power correction when transmitting the SRS from the SRS port at a transmit power below the maximum configured transmit power.

8. The UE of claim 1, wherein the at least one processor is operable to cause the UE to:
receive an instruction to not apply the power correction when transmitting below a maximum configured transmit power; and
avoid applying the power correction when transmitting the SRS from the SRS port at a transmit power below the maximum configured transmit power.

9. The UE of claim 1, wherein the at least one processor is operable to cause the UE to transmit an indication of one or more power relaxation values for the SRS port.

10-18. (canceled)

19. An network entity for wireless communication, comprising:
at least one memory; and
at least one processor coupled with the at least one memory and operable to cause the network entity to:
transmit an indication of a power correction to be applied to a sounding reference signal (SRS) port; and
receive one or more SRS transmitted from the SRS port.

20. A method performed by a user equipment (UE), the method comprising:
receiving an indication of a power correction to be applied to a sounding reference signal (SRS) port; and
applying the power correction when transmitting SRS from the SRS port.

21. The method of claim 20, wherein the indication comprises one or more power corrections to be applied to each SRS port of multiple SRS ports, and the method further comprising applying a respective power correction to each SRS port of the multiple SRS ports.

22. The method of claim 20, further comprising:
applying the power correction as a correction term to an SRS power control equation.

23. The method of claim 22, wherein the correction term comprises one or more SRS port-based offsets.

24. The method of claim 20, further comprising:
transmitting an indication of whether the UE applies the power correction to compensate for power relaxation for SRS transmission.

25. The method of claim 24, wherein the indication indicates whether the UE applies the power correction to compensate for the power relaxation for SRS transmission when transmitting below a maximum configured transmit power.

26. The method of claim 20, further comprising:
receiving an instruction to apply the power correction when transmitting below a maximum configured transmit power; and
applying the power correction when transmitting the SRS from the SRS port at a transmit power below the maximum configured transmit power.

27. The method of claim 20, further comprising:
receiving an instruction to not apply the power correction when transmitting below a maximum configured transmit power; and
avoiding applying the power correction when transmitting the SRS from the SRS port at a transmit power below the maximum configured transmit power.

28. The method of claim 20, further comprising:
transmitting an indication of one or more power relaxation values for the SRS port.

29. A method performed by a network entity, the method comprising:
transmitting an indication of a power correction to be applied to a sounding reference signal (SRS) port; and
receiving one or more SRS transmitted from the SRS port.
